(19) United States
(12) Patent Application Publication
(10) Pub. No.: US 2007/0174119 A1
(43) Pub. Date: Jul. 26, 2007

(54) Method, system, and program product for graphically representing a marketing optimization

(75) Inventors: Mark S. Ramsey, Kihei, HI (US); David A. Selby, Nr Fareham (GB); Stephen J. Todd, Winchester (GB)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/338,543

(22) Filed: Jan. 24, 2006

(51) Int. Cl. G06Q 30/00

(52) U.S. Cl. 705/14

(57) ABSTRACT

The invention provides a method, system, and program product for graphically representing a marketing optimization. In one embodiment, the method includes: selecting from a plurality of promotion events a promotion event having the highest return ratio (RR); graphically displaying the RR of the selected promotion event as a function of a cumulative cost of all selected promotion events; and repeating the selecting and graphically displaying steps from among unselected promotion events.

### BACKGROUND OF THE INVENTION

1. Technical Field

The invention relates generally to marketing optimization, and more particularly, to a method, system, and program product for graphically representing a marketing optimization.

2. Background Art

Direct marketing involves advertising to customers at a location other than the point of sale. Catalogs, first-class mail, telemarketing, and e-mail are some examples of direct marketing techniques that are currently utilized to promote the sale of goods or services.

Increasingly, retail companies are adding direct marketing to their mix of marketing techniques. In addition, with the explosion of the Internet and e-commerce, consumers are presented with increasingly attractive alternatives to mail for the direct purchase of goods and services in their homes.

In response to these changes, direct marketers have responded in a variety of ways. Many direct marketers have improved their targeting of recipients of direct marketing through automation. For example, automation has been achieved by programming computers to perform sophisticated statistical analysis and modeling, develop marketing databases, increase the sophistication of their predictive models, or enhance their current processes with leading edge marketing tools such as data mining. While these efforts have helped reduce the negative impact of the changing marketing atmosphere, the industry has not been able to improve the average response rate to direct marketing.

A commonly-used marketing technique is called the RFM (Recency, Frequency and Monetary Value) technique. PCT International Application No. PCT/US98/22613, published as International Publication No. WO 99/22328, incorporated herein by reference, discloses a computer-implemented targeted marketing system which evaluates many factors, including the RFM factors, to determine a customer list to be used for sending marketing materials in connection with a single proposed promotion event. The RFM technique is based on the theory that the customers that are most likely to respond to a proposed direct marketing event (e.g., a mailing of an offer) are those that have most recently been customers (Recency), and that have frequently been repeat customers (Frequency), and that have purchased significant dollar amounts (Monetary Value). Existing customers are scored based on their characteristics related to each of these three criteria, and a customer with a high RFM score is considered a good target for the proposed marketing event under analysis. Based on the RFM scores, a specialized customer list is generated for a single proposed marketing event.

Whether the decision to include a particular customer in a promotion event is based on an RFM score or some other criterion, the decision is ultimately one of cost versus benefit. More specifically, the decision is one of the cost of including a particular customer or group of customers in a promotion event (e.g., cost[event]) versus the expected monetary return in doing so (e.g., benefit[event]).

For example, referring to FIG. 1, a table 10 of costs 40 and benefits 60 is shown for each of a plurality of promotion events 20. Table 10 may represent any of a number of combinations of promotion events, customers, or groups of customers, depending on the needs of a user. For example the plurality of events 20 may represent the application of distinct events to the same customer or group of customers. Alternatively, the plurality of events 20 may represent the application of the same event to different customers or groups of customers. In either case, it can be seen that the costs and benefits associated with each event differ. Accordingly, table 10 may be used in determining which customer or group of customers will be included in a particular event.

For example, assume that table 10 represents the application of distinct events to the same customer. Table 10 shows that it will cost $7.00 to include the customer in Event 1, while the expected benefit in doing so is $4.00. As such, the customer is unlikely to be included in Event 1. However, the cost of including the customer in Event 2 is $6.00, while the expected benefit in doing so is $7.00. As such, the customer is more likely to be included in Event 2 than in Event 1.

It may seem, therefore, that the customer should be included in any event in which the benefit in doing so is greater than the cost of doing so. However, given budgetary and logistical constraints, it is generally impractical to do so. To maximize the efficiency of promotion events as a whole, it is necessary to prioritize the events based on their respective costs and benefits.

A common method for doing so is to calculate a return ratio (RR), defined as the benefit of an event divided by its cost. For example, the RR for Event 1 is 0.57 and the RR for Event 2 is 1.167. The events 20 of table 10 may be ordered according to a calculated RR value for each. However, the resulting order is not immediately obvious from table 10. The order, listed from highest RR to lowest, is: Event 4 (RR 1.67), Event N (RR 1.5), either Event 3 or Event 7 (RR 1.33), Event 2 (RR 1.167), Event 5 (RR 1.0), Event 1 (RR 0.57) and Event 6 (RR 0.286).

However, even if the plurality of events 20 were so arranged, it is neither obvious nor intuitive when investment in the customer should be ended in favor of investment in another customer or group of customers. Such a decision is fact-specific, depending, for example, on the remaining budget, the availability of other customers or events on which the remaining budget may be spent, the rate at which costs are incurred, the rate at which benefits will accrue, etc.

To this extent, a need exists for a method of representing a marketing optimization that allows easy identification of incurred costs and realized benefits, among other factors.

### SUMMARY OF THE INVENTION

The invention provides a method, system, and program product for graphically representing a marketing optimization. In one embodiment, the method includes: selecting from a plurality of promotion events a promotion event having the highest return ratio (RR); graphically displaying the RR of the selected promotion event as a function of a cumulative cost of all selected promotion events; and repeating the selecting and graphically displaying steps from among unselected promotion events.

A first aspect of the invention provides a method for representing a result of a marketing optimization, the method comprising: selecting from a plurality of promotion events a promotion event having the highest return ratio (RR); graphically displaying the RR of the selected promotion event as a function of a cumulative cost of all selected promotion events; and repeating the selecting and graphically displaying steps from among unselected promotion events.

A second aspect of the invention provides a method for representing a result of a marketing optimization, the method comprising: sorting each of a plurality of promotion events into one of a plurality of groups; selecting from the plurality of groups a group having the highest return ratio (RR); graphically displaying the RR of the selected group as a function of a cumulative cost of all selected groups; and repeating the selecting and graphically displaying steps from among unselected groups.

A third aspect of the invention provides a system for representing a result of a marketing optimization, the system comprising: a system for sorting each of a plurality of promotion events into one of a plurality of groups; a system for selecting from the plurality of groups a group having the highest return ratio (RR); and a system for graphically displaying the RR of the selected group as a function of a cumulative cost of all selected groups.

A fourth aspect of the invention provides a program product stored on a computer-readable medium, which when executed, graphically represents a marketing optimization, the program product comprising: program code for sorting each of a plurality of promotion events into one of a plurality of groups; program code for selecting from the plurality of groups a group having the highest return ratio (RR); and program code for graphically displaying the RR of the selected group as a function of a cumulative cost of all selected groups.

A fifth aspect of the invention provides a method for deploying an application for graphically representing a marketing optimization, comprising: providing a computer infrastructure being operable to: sort each of a plurality of promotion events into one of a plurality of groups; select from the plurality of groups a group having the highest return ratio (RR); graphically display the RR of the selected group as a function of a cumulative cost of all selected groups; and repeat the selecting and graphically displaying steps from among unselected groups.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a promotion event cost/benefit table known in the art.

FIGS. 2-3 show graphical displays of marketing optimizations according to the invention.

FIG. 4 shows a block diagram of an illustrative method according to the invention.

FIG. 5 shows an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method, system, and program product for graphically representing a marketing optimization.

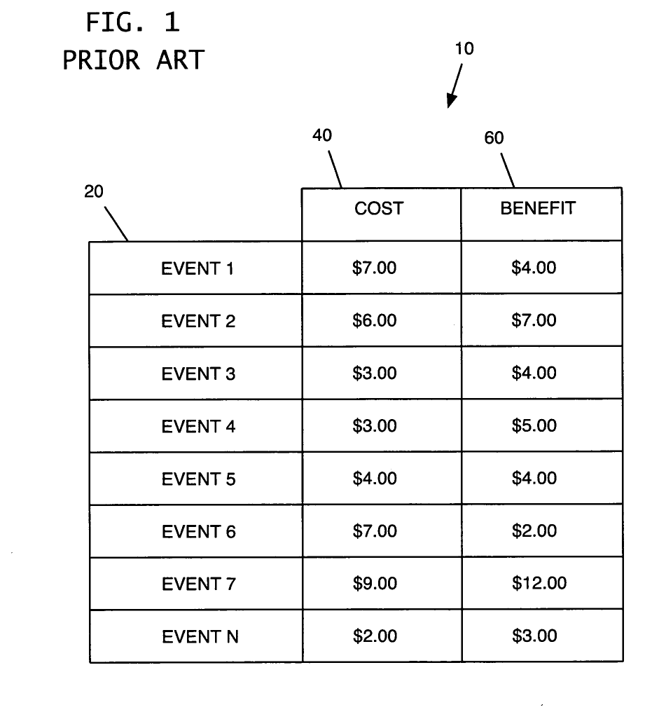

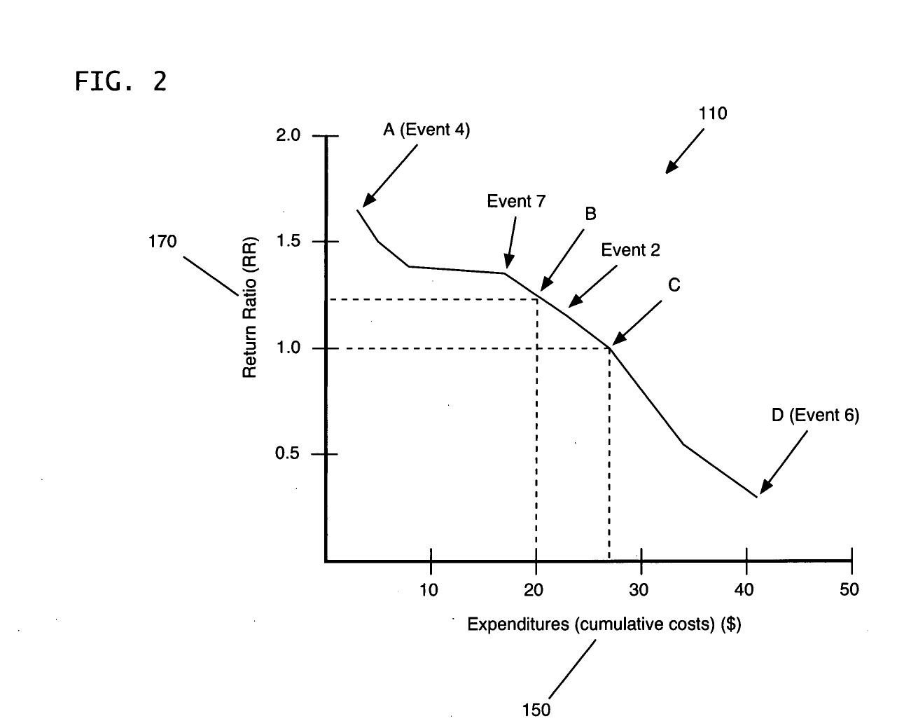

Referring now to FIG. 2, a graphical display 110 of the data of table 10 (FIG. 1) is shown, according to an embodiment of the invention. Graphical display 110 plots the calculated return ratio (RR) of each promotion event against total expenditures (i.e., cumulative costs 40 (FIG. 1)). For example, considering all eight events in table 10, point A represents the highest RR of the plurality of events 20 (FIG. 1), i.e., Event 4, having an RR of 1.67. Similarly, point D represents the lowest RR of the plurality of events 20, i.e., Event 6, having an RR of 0.286. To maximize the total benefit, promotion events are chosen in decreasing order of RR, as described above.

Graphical display 110 provides much more usable information than table 10, and presents the data in an easily-understandable and more useful form. For example, a user may wish to know how much money would need to be expended in order to include the customer in every promotion event having an RR greater than or equal to 1.0. Graphical display 110 makes it easy to see that at point C, a total of $27 would have to be expended to include the customer in every such promotion event.

Alternatively, a user may want to know how many and which promotion events the customer may be included in, given a total budget of $20. This information is also readily apparent from graphical display 110. At point B, a total of $20 will have been expended. However, point B lies between Event 7 and Event 2. Accordingly, the customer may be included only in promotion events up to Event 7 (i.e., Events 4, N, 3, and 7), as inclusion of the customer in Event 2 would require a total expenditure of $23. Inclusion of the customer only in events up to Event 7 requires a total expenditure of only $17, resulting in a savings of $3 from the $20 budget.

Comparing graphical displays of marketing optimization data, such as graphical display 110, allows a user to better allocate resources. For example, if a graphical display of RRs and expenditures associated with another plurality of promotion events (not shown) indicated that, for an equal expenditure, higher RRs would be realized than those shown in graphical display, a user may choose to include the customer in fewer promotion events. For example, a user may choose to expend only $5 on the customer, including him/her in only Events 4 and N, and expending the remaining $15 of the budget including a different customer in the same or other promotion events, where greater RRs may be realized.

More typically, marketing optimization will be performed for a much larger number of promotion events and/or customers or groups of customers. Often, many thousands of customers and/or promotion events will be involved, making the need for a graphical representation of such data even more evident. However, when so many customers and/or promotion events are involved, it is generally neither desirable nor practical to select individual promotion events as applied to individual customers or groups of customers. Rather, in such a case, it is an object of the present invention to separate promotion events based on their costs and benefits, and more particularly, their return ratios (RRs), into predefined groups (G) prior to graphically displaying such marketing optimization data.

For example, given 10,000 cost and benefit values (e.g., 10,000 promotion events applied to a single customer, a single promotion event applied to 10,000 customers, or any intermediate combination thereof), it may be desirable to separate such values into N groups, according to predefined ranges of RRs. Group 1, for example, may have a range of RR values between 8 and 10, group 2 may have a range of RR values between 6 and 7.9, etc. Alternatively, the 10,000 values may be evenly separated into N groups. Each of 100 groups may, for example, contain the values associated with 100 promotion events. In either case, it is the aggregate value of each group that will be used to determine whether a customer or group of customers will be included in a promotion event or group of promotion events within the group.

Group values may be calculated simply as the sums of the event values within the group. For example, group values may be expressed as:

Group 1 cost=Cost[G1]=SUM(cost[Event 1], cost[Event 2], . . . cost[Event N]);

Group 1 benefit=Benefit[G1]=SUM(benefit[Event 1], benefit[Event 2], . . . benefit[Event N]); and

Group 1 return ratio=RR[G1]=Cost[G1]/Benefit[G1],
wherein Event 1, Event 2, . . . Event N are the promotion events contained within Group 1.

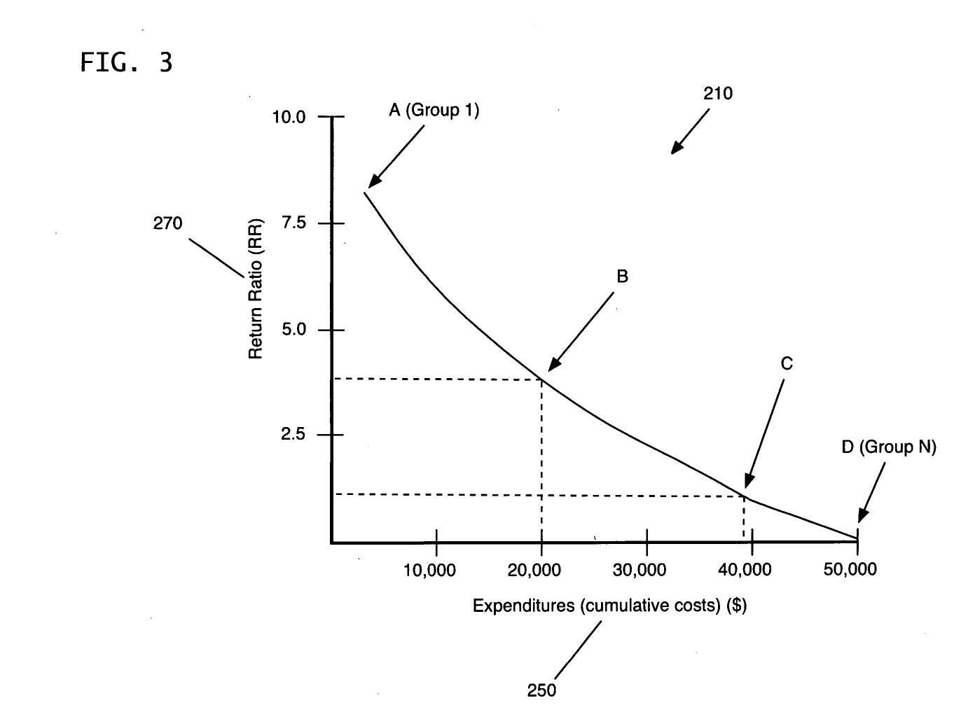

As above in FIG. 2, the RRs and cumulative costs of each Group may be displayed. FIG. 3 shows such a graphical display 210, including RR values 270 and Expenditures 250. Given the relatively greater number of promotion events (i.e., 10,000) and Group values (e.g., 100 or more), the curve of FIG. 3 is more even and extends over a greater RR range than that shown in FIG. 2, since the values are more likely to follow a more normal distribution.

However, as in FIG. 2, a user is still able to easily discern from graphical display 210 the point at which the RR falls below 1.0 (i.e., point C, corresponding to an expenditure of approximately $39,000). Similarly, graphical display 210 allows a user to determine the RR associated with a predetermined expenditure (e.g., at point B, $20,000 has been expended). These and other benefits of providing marketing optimization results graphically, as in graphical displays 110 and 210, will be recognized by one having ordinary skill in the art.

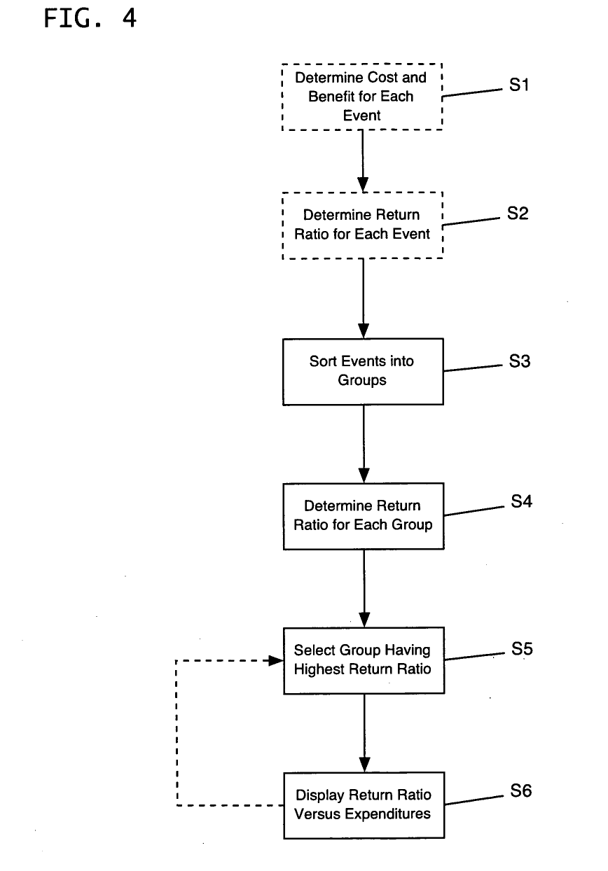

Referring now to FIG. 4, a block diagram of an illustrative method according to the invention is shown. At step S3, each of a plurality of promotion events is sorted into one of a plurality of groups, based, for example, on one or more of a cost, benefit, and RR of the promotion event. At step S4, an RR is determined for each group. As described above, the RR of each group may be based on the costs, benefits, and/or return ratios of the promotion events it contains. More specifically, the RR of a group may be defined as the sum of the benefits of its promotion events divided by the sum of the costs of its promotion events. At step S5, the group having the highest RR is selected and at step S6, the RR of the selected group is displayed as a function of total expenditures. Steps S5 and S6 may be iterated for a predetermined number of times, until a predetermined total expenditure is reached, or until all groups are selected and displayed. It should be noted that for the first group selected and displayed, the values displayed will be the RR of the first group versus the cost of the first group; for the second group selected and displayed, the values will be the RR of the second group versus the summed costs of the first and second groups; and so forth. In the case that the cost, benefit, and RR of each promotion event has not already been determined, the method may further contain the steps of determining the cost and benefit for each promotion event at step S1 and determining the RR of each event at step S2.

Whether used to display cost and benefit values associated with individual promotion events (as in FIG. 2) or groups of promotion events (as in FIG. 3), the process steps of the present invention may be distinct or overlap in time. For example, the cost and benefit values associated with each promotion event may calculated, used to calculate an RR value, and then the RR values and cumulative costs may be displayed. Alternatively, any cost, benefit, RR, and cumulative cost values may be calculated and/or displayed as other values continue to be calculated. That is, the display step and calculation steps may overlap or be “pipelined.” This allows for a “real-time” display of marketing optimization data, whether the collection of data and calculation of such values occurs over the course of seconds, minutes, hours, days, months, or longer.

Similarly, while cost, benefit, RR, and cumulative cost values may be taken and displayed directly from the calculation step, one or all such values may alternatively be read from a table, matrix, array, or similar database. That is, such values may be “live,” in that they are not read from a database, or “stored,” in that they are read from a database. In either case, the display data according to the invention may be saved in a format such that one or more of the cost, benefit, RR, and cumulative cost values may be derived from the display data.

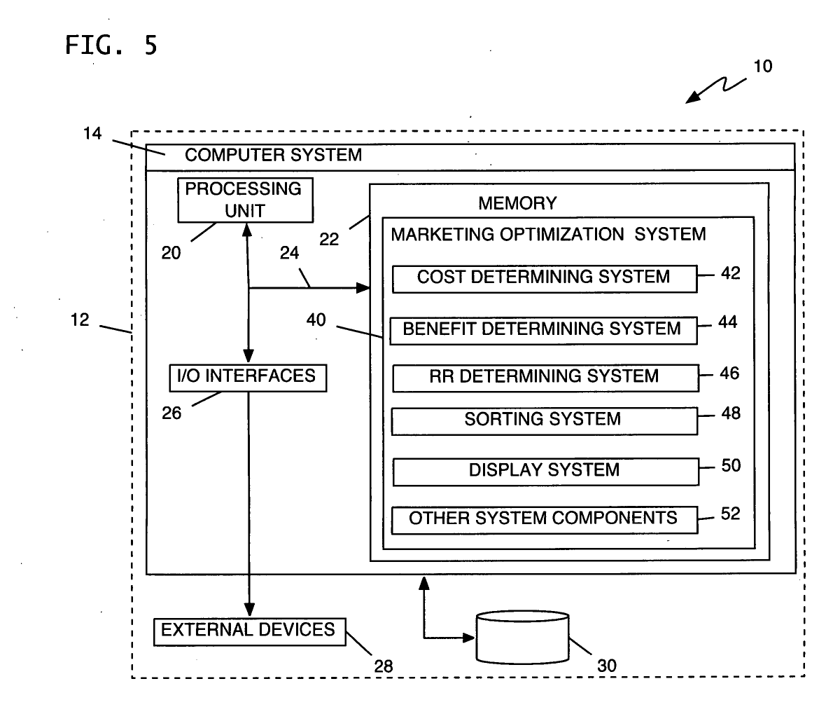

FIG. 5 shows an illustrative system 10 for graphically representing a marketing optimization. To this extent, system 10 includes a computer infrastructure 12 that can perform the various process steps described herein for graphically representing a marketing optimization. In particular, computer infrastructure 12 is shown including a computer system 14 that comprises a marketing optimization system 40, which enables computer system 14 to graphically represent a marketing optimization by performing the process steps of the invention.

Computer system 14 is shown including a processing unit 20, a memory 22, an input/output (I/O) interface 26, and a bus 24. Further, computer system 14 is shown in communication with an external devices 28 and a storage system 30. As is known in the art, in general, processing unit 20 executes computer program code, such as marketing optimization system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and marketing optimization system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, marketing optimization system 40 enables computer system 14 to graphically represent a marketing optimization. To this extent, marketing optimization system 40 is shown including a cost determining system 42, a benefit determining system 44, a return ratio (RR) determining system 46, a sorting system 48, and a display system 50. Operation of each of these systems is discussed above. Marketing optimization system 40 may further include other system components 52 to provide additional or improved functionality to marketing optimization system 40. It is understood that some of the various systems shown in FIG. 5 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for graphically representing a marketing optimization, it is understood that the invention further provides various alternative embodiments. For example, in one embodiment, the invention provides a computer-readable medium that includes computer program code to enable a computer infrastructure to graphically represent a marketing optimization. To this extent, the computer-readable medium includes program code, such as marketing optimization system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to graphically represent a marketing optimization as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for graphically representing a marketing optimization. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for representing a result of a marketing optimization, the method comprising:
selecting from a plurality of promotion events a promotion event having the highest return ratio (RR);
graphically displaying the RR of the selected promotion event as a function of a cumulative cost of all selected promotion events; and
repeating the selecting and graphically displaying steps from among unselected promotion events.

2. The method of claim 1, wherein RR is an expected monetary benefit associated with a promotion event divided by a cost associated with the promotion event.

3. The method of claim 1, wherein each of the plurality of promotion events is associated with the same customer.

4. The method of claim 1, wherein each of the plurality of promotion events is associated with a different customer.

5. The method of claim 1, wherein a first portion of the plurality of promotion events is associated with a first customer and a second portion of the plurality of promotion events is associated with a second customer.

6. The method of claim 1, wherein the selecting step and the graphically displaying step overlap.

7. The method of claim 1, further comprising:
calculating an RR for each of the plurality of promotion events.

8. A method for representing a result of a marketing optimization, the method comprising:
sorting each of a plurality of promotion events into one of a plurality of groups;
selecting from the plurality of groups a group having the highest return ratio (RR);
graphically displaying the RR of the selected group as a function of a cumulative cost of all selected groups; and
repeating the selecting and graphically displaying steps from among unselected groups.

9. The method of claim 8, wherein RR is a sum of expected monetary benefits associated with the promotion events of the group divided by the sum of costs associated with the promotion events of the group.

10. The method of claim 8, wherein the sorting step is based on an RR value of the promotion event.

11. The method of claim 8, wherein each of the plurality of promotion events is associated with the same customer.

12. The method of claim 8, wherein each of the plurality of promotion events is associated with a different customer.

13. The method of claim 8, wherein a first portion of the plurality of promotion events is associated with a first customer and a second portion of the plurality of promotion events is associated with a second customer.

14. The method of claim 8, further comprising:
calculating an RR for each of the plurality of groups.

15. The method of claim 14, further comprising:
calculating an RR for each of the plurality of promotion events.

16. A system for representing a result of a marketing optimization, the system comprising:
a system for sorting each of a plurality of promotion events into one of a plurality of groups;
a system for selecting from the plurality of groups a group having the highest return ratio (RR); and
a system for graphically displaying the RR of the selected group as a function of a cumulative cost of all selected groups.

17. The system of claim 16, further comprising:
a system for calculating an RR for each of the plurality of groups.

18. The system of claim 16, further comprising:
a system for calculating an RR for each of the plurality of promotion events.

19. The system of claim 16, further comprising:
a system for repeating the selecting and graphically displaying steps from among unselected groups.

20. A program product stored on a computer-readable medium, which when executed, graphically represents a marketing optimization, the program product comprising:
program code for sorting each of a plurality of promotion events into one of a plurality of groups;
program code for selecting from the plurality of groups a group having the highest return ratio (RR); and
program code for graphically displaying the RR of the selected group as a function of a cumulative cost of all selected groups.

21. The program product of claim 20, further comprising:
program code for repeating the selecting and graphically displaying steps from among unselected groups.

22. The program product of claim 20, further comprising:
program code for calculating an RR for each of the plurality of groups.
